(19) United States
(12) Patent Application Publication
(10) Pub. No.: US 2008/0118908 A1
(43) Pub. Date: May 22, 2008

(54) METHOD OF SELECTING A SPERM CELL BASED ON ITS DNA CONTENT

(75) Inventor: Dmitri Dozortsev, Katy, TX (US)

Correspondence Address: DMITRI DOZORTSEV, 858 SHILLINGTON DR, KATY, TX, 77450, US

(73) Assignee: Dmitri Dozortsev, Katy, TX (US)

(21) Appl. No.: 11/941,136

(22) Filed: Nov. 16, 2007

Related U.S. Application Data
(60) Provisional application No. 60/859,663, filed on Nov. 17, 2006.

(51) Int. Cl. A01N 1/02

(52) U.S. Cl. 435/2

(57) ABSTRACT

The method and process for sex selection based on a quantitative DNA measurement in spermatozoa with damaged plasma membrane.

This application claims priority of U.S. Provisional Patent Application Ser. No. 60/859,663 filed Nov. 17, 2006, which is incorporated herein by reference.

### TECHNICAL FIELD OF THE INVENTION

This invention relates to a method of preselecting the sex of offspring by identifying X and Y chromosome-bearing sperm based on the differences in their DNA content.

### BACKGROUND OF THE INVENTION

Sperm sex sorting is a valuable technique used in farm animals and more recently in humans. About a thousand children have been born following sex sorting for gender selection which was performed as a part of a clinical trial under FDA pre-marketing research guidelines.

Sperm sorting is based on detection of about 3% difference in DNA content between spermatozoa carrying Y (male) and X (female) chromosome.

Previously, a patent was awarded for using flow cytometry for cell sorting to separate live, intact sperm cells based on their DNA content to enrich the sperm sample with spermatozoa of desirable sex (U.S. Pat. No. 5,135,759). Similar process was recently applied to enrich sperm sample with chromosomally normal sperm cells (US patent application 20060257909). Several other patents have been issued that address different aspects of enrichment of sperm population with X or Y bearing spermatozoa to achieve sex selection prior to fertilization.

The patented techniques are based on quantification of DNA in live spermatozoa following their staining with one of the fluorescent dyes (such as Hoechst for example), exposing to the excitation light of a laser and measuring the emitted light. This selection is carried out on live spermatozoa using flowcytometer.

The technique works well in bulls, but is not as effective in humans. One of the main reasons for lower efficiency in humans is poor control of spermatozoa's orientation in the flow relative to the laser and detector. Quantitative measurement requires a strict orientation of the sperm cell in the flow. Bull's sperm has a flat shape and therefore its orientation in the flow of fluid is easily achieved. Unlike bull's sperm, human spermatozoa are not flat and their orientation in the flow is problematic resulting in relatively low accuracy.

Another disadvantage of the existing technique is that it requires high quality sperm samples and patients with any kind of sperm problems do not qualify for sperm sorting. Furthermore, operation of flowcytometer requires significant expertise

### SUMMARY OF THE INVENTION

According to the present invention DNA measurement for gender selection is done on an individual sperm cell (cells) that has been killed by damaging sperm plasma membrane using a glass instrument or freezing/thawing or laser or some other protocol. Such spermatozoa would be judged as dead using conventional assays; however, they retain full developmental potential (Dozortsev et al, 2005). After DNA measurement the sperm cell (cells) will be used for fertilization using Intracytoplasmic Sperm Injection (ICSI).

### DETAILED DESCRIPTION OF THE INVENTION

There are several key features that set current invention apart from prior art.

The prior art requires that spermatozoon remained intact, alive and motile thorough the procedure. Current method requires that the sperm plasma membrane be damaged, rendering sperm immotile, prior to the measurement. Plasma membrane damage is irreversible and permanent so that the sperm cell would be judged as dead using conventional assays, such as dye exclusion. Immobilization allows accurate sperm orientation relative to the laser and detector.

In the prior art the orientation of the sperm head relative to the exciting laser and the emitted light detector is achieved by flow of liquid. In the current invention, the orientation of the sperm head relative to the beam of the exciting laser is determined by gravity and/or by manual operation whereby the spermatozoon is rotated into the optimal position.

In the prior art the end product is a suspension of sorted spermatozoa. In the current invention, the end product is an individual spermatozoon with an assigned probability of being male or female.

The algorithm of the invention is summarized as following.

a) Sperm plasma membrane damage using glass pipette, freezing-thawing or any other number of techniques.
b) Staining of the sperm nucleus with the fluorescent dye (i.e. Hoechst, DAPI etc)
c) Positioning of the Petri dish containing stained sperm cells under inverted microscope.
d) Exposing sperm cells to the laser light and capturing the emitted light using photomultiplier and plotting the obtained values for each individual sperm cell on the computer screen next to the image of the respective spermatozoon so that operator can trace them back to the actual spermatozoa in the Petri dish.
e) Picking up the selected sperm cell with the injection pipette and injecting it into the oocyte.

Because of a large inter-patient variation between sperm samples, the values corresponding to the predicted X or Y bearing chromosomes would have to be determined for every patient's sample by measuring the excitation of a certain number of cells in each sample prior to proceeding to selection.

The disclosed method requires at least the following items:

a) Inverted microscope
b) Micromanipulator
c) Laser
d) Photomultiplier
e) Computer
f) Quantification software
g) DNA stain

The present invention offers the following improvements over existing technology:

a) It is applicable to the sperm sample of virtually any quality and quantity
b) The actual sperm cell that will be used for fertilization is characterized, not merely a sperm population
c) It can be incorporated into ICSI procedure
d) Possibility of calculating several parameters for the specific sperm cells (shape, size ets) and correlated with the results of DNA measurement, thereby increasing the probability of choosing a sperm cell of a desirable chromosomal complement.
e) Volumetric measurement, negating the variability of orientation and shape
g) Because the sperm membrane is damaged, this increases the choice of the DNA stains that can be used for DNA measurement and may even include the stains that do not emit light, such as, for example Eosin B.
f) higher accurate

### REFERENCES CITED

U.S. Pat. No. 5,135,759
US patent application 20060257909
D. Dozortsev et al., “Sperm plasma membrane damage prior to intracytoplamic sperm injection: a necessary condition for the sperm nucleus decondensation,” Hum. Reprod. 10: 2960-2965, (1995).
D. Dozortsev et al., “Human oocyte activation following intracytoplasmic injection: the role of the sperm cell,”. Hum. Reprod. 10: 403-407, (1995).

What claimed is:

1. The method of selecting X or Y bearing spermatozoa with damaged plasma membrane (dead by conventional criteria) based on their DNA content comprising of:
a) Inducing sperm plasma membrane damage using a pipette, freezing-thawing, laser or any other number of techniques
b) Staining sperm nucleus with the fluorescent dye
c) Placing a Petri dish containing stained sperm cells under inverted microscope.
d) Exposing sperm cells to the laser light and capturing the emitted light using photomultiplier or similar device and plotting the obtained values for each individual sperm cell on the computer screen next to the image of the respective spermatozoon so that operator can trace them back to the actual spermatozoa in the Petri dish.
e. Picking up the selected sperm cell with an injection pipette and injecting it into the oocyte.

2. The method of claim 1, wherein the said step b is performed before step a.

3. The method of claim 1, wherein during the said step d only spermatozoa with the specific orientation are scored.

4. The method of claim 1, wherein prior to said step d the spermatozoon of interest is manually oriented into the desirable position using micromanipulator.

5. The method of claim 1, wherein prior to d, more than 1 spermatozoon from the same patient are subjected to the DNA quantification to determine the sperm DNA values distribution between spermatozoa in this specific sample.

6. The method of claim 1 where the media in the said steps a, b, c, d or e contains Polyvinylpyrrolidone or a similar substance that reduces sperm sticking and/or slows down sperm cells movement.

7. The method of claim 1, wherein prior to the said step e, the spermatozoon is washed out of DNA stain.

8. The method of claim 1, wherein during the said step d, the geometry of the spermatozoon is taken into account during the calculations.

9. The method of claim 1, wherein the source of light is not a laser.
